(19) United States
(12) Patent Application Publication
(10) Pub. No.: US 2025/0286969 A1
(43) Pub. Date: Sep. 11, 2025

(54) IMAGE READING APPARATUS AND IMAGE FORMING APPARATUS

(71) Applicant: CANON KABUSHIKI KAISHA, Tokyo (JP)

(72) Inventor: RYOHEI SHIMMA, Chiba (JP)

(21) Appl. No.: 19/065,927

(22) Filed: Feb. 27, 2025

(30) Foreign Application Priority Data
Mar. 11, 2024 (JP) 2024-037565

(51) Int. Cl. H04N 1/00; G03G 15/22

(52) U.S. Cl. CPC H04N 1/00557; G03G 15/228; H04N 1/00551; H04N 1/00615

(57) ABSTRACT

An image reading apparatus includes a transparent member having a placing surface on which a sheet is placed, a first abutment portion against which an edge portion of the sheet on a rear side in a front-rear direction abuts, a second abutment portion against which an edge portion of the sheet on one side in a left-right direction abuts, a first size indicator provided on a rear side with respect to the placing surface and indicates a size of the sheet in the left-right direction, a second size indicator provided on the one side with respect to the placing surface and indicates a size of the sheet in the front-rear direction, and a third size indicator provided on a front side with respect to the placing surface and includes a scale for measuring a length of the sheet in the left-right direction.

### BACKGROUND

### Field

The present disclosure relates to an image reading apparatus that reads an image of a sheet and an image forming apparatus including the image reading apparatus.

### Description of the Related Art

Conventionally, an image forming apparatus, such as a copier, is equipped with an image reading apparatus that optically reads an image of a document. Such an image reading apparatus is configured to read an image of a document by moving an optical member under a transparent platen made of glass, or the like, in a state where the document is placed on the platen. Bumps are provided at end portions of the platen, on which the document is placed, in the front-rear direction and the left-right direction. When the user sets the document on the platen, the edge portions of the document abut against the bumps to be positioned. For example, the document is positioned with reference to the rear side and the left side of the platen.

In this type of known image reading apparatuses, a size indicator indicating a size of a document is provided near an abutment portion against which an edge portion of the document abuts. Japanese Patent Application Laid-Open No. 2003-140278 discusses an image reading apparatus in which a size indicator having a printed mark indicating the size of a document in the lateral direction (left-right direction) is provided near the rear end portion of the platen, and a size indicator having a printed mark indicating the size of the document in the longitudinal direction (depth direction) is provided near the left end portion of the platen. These size indices include characters indicating standard sizes (e.g., A4 and A3) and indicate the standard size to which the document corresponds. Provision of such a size indicator makes the user easily confirm that the document is set at a correct position and check the document size.

The above-described size indicator is sometimes used to measure the size of a sheet such as a document or recording paper having an image formed thereon. However, using only the size indicator indicating the standard size may make it difficult for the user to measure the size of a sheet having a non-fixed size.

### SUMMARY

The present disclosure is directed to providing an image reading apparatus and an image forming apparatus with which a user can easily measure the size of a sheet.

According to an aspect of the present disclosure, an image reading apparatus includes a transparent member having a placing surface on which a sheet is placed, a reading unit configured to read an image of the sheet set at a predetermined position on the placing surface, a first abutment portion against which an edge portion of the sheet on a rear side in a front-rear direction of the image reading apparatus abuts when the sheet is set at the predetermined position on the placing surface, a second abutment portion against which an edge portion of the sheet on one side in a left-right direction orthogonal to the front-rear direction abuts when the sheet is set at the predetermined position on the placing surface, a first size indicator provided on a rear side with respect to the placing surface in the front-rear direction and configured to indicate a size of the sheet in the left-right direction in a state where the sheet is set at the predetermined position, the first size indicator including a plurality of characters indicating a standard size, a second size indicator provided on the one side with respect to the placing surface in the left-right direction and configured to indicate a size of the sheet in the front-rear direction in a state where the sheet is set at the predetermined position, the second size indicator including a plurality of characters indicating a standard size, and a third size indicator provided on a front side with respect to the placing surface in the front-rear direction and configured to include a scale to measure a length of the sheet in the left-right direction.

Further features of the present disclosure will become apparent from the following description of exemplary embodiments with reference to the attached drawings.

### BRIEF DESCRIPTION OF THE DRAWINGS

FIG. 1 is a schematic cross-sectional view of an image forming apparatus.

FIG. 2 is a perspective view of an image reading apparatus.

FIG. 3 is a schematic cross-sectional view of the image reading apparatus.

FIG. 4 is a perspective view of an image reading unit.

FIG. 5 is a top view of the image reading unit.

FIG. 6 is a perspective view of a front exterior.

FIG. 7 is a perspective view illustrating another example of the image reading apparatus.

FIG. 8 is a perspective view of the image reading apparatus in a state where an auto document feeder (ADF) is opened.

### DESCRIPTION OF THE EMBODIMENTS

Exemplary embodiments of the present disclosure will now be described with reference to the accompanying drawings. The following exemplary embodiment is an example embodying the present disclosure and is not intended to limit the technical scope of the present disclosure.

### <Configuration of Image Forming Apparatus>

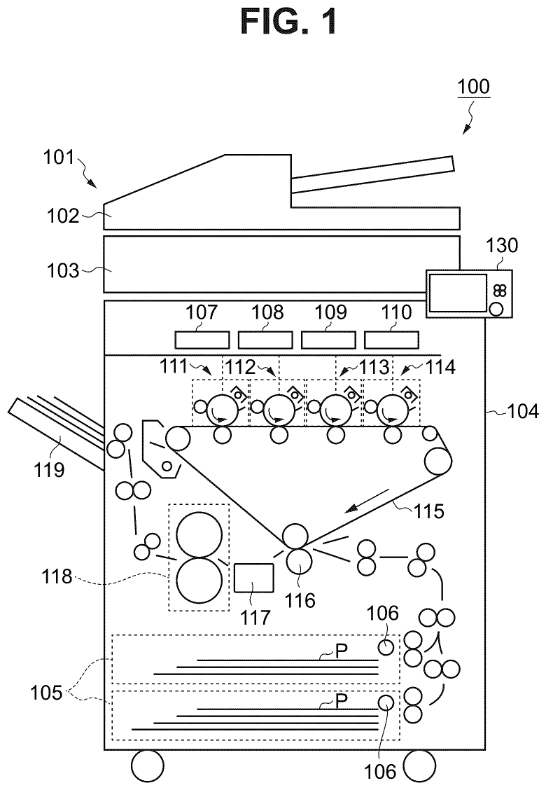

An image forming apparatus 100 according to the present exemplary embodiment will be described with reference to FIG. 1. FIG. 1 is a schematic cross-sectional view of the image forming apparatus 100 as viewed from the front. The image forming apparatus 100 includes an operating unit 130 for a user to perform various settings on the image forming apparatus 100.

The operating unit 130 includes a start button for the user to provide an instruction to start printing or an instruction to start reading and a display for displaying information to the user. According to the present exemplary embodiment, the position where the user faces the operating unit 130 is hereinafter referred to as the “front side” of the apparatus, and the back side is hereinafter referred to as the “rear side”. That is, FIG. 1 illustrates an internal configuration of the image forming apparatus 100 as viewed from the front side. According to the present exemplary embodiment, the direction from the front side to the rear side of the apparatus is referred to as the “front-rear direction”, and the direction from the left side to the right side when the apparatus is viewed from the front side is referred to as the “left-right direction”. That is, the left-right direction is a direction orthogonal to the front-rear direction and is a horizontal direction.

As illustrated in FIG. 1, the image forming apparatus 100 includes a main body 104 of the image forming apparatus 100 and an image reading apparatus 101 provided above the main body 104. The image forming apparatus 100 forms a toner image on a sheet P based on image data read by the image reading apparatus 101 or an image signal from a host device such as a personal computer communicably connected to the image forming apparatus 100. Examples of the sheet P serving as a recording medium include sheet materials such as plain paper, plastic film, and cloth.

The main body 104 of the image forming apparatus 100 includes therein laser scanners 107 to 110 and image forming units 111 to 114, which are image forming portions using an electrophotographic system and correspond to respective colors of yellow, magenta, cyan, and black (YMCK), and a fixing unit 118. The laser scanners 107 to 110 irradiate laser to photoconductors included in the corresponding image forming units 111 to 114 based on input image signals. The image forming units 111 to 114 are provided along an intermediate transfer belt 115.

The image forming unit 111 forms a yellow toner image, and the formed yellow toner image is primarily transferred onto the intermediate transfer belt 115. The image forming unit 112 forms a magenta toner image, and the formed magenta toner image is primarily transferred to be superimposed on the yellow toner image transferred onto the intermediate transfer belt 115. The image forming unit 113 forms a cyan toner image, and the formed cyan toner image is primarily transferred to be superimposed on the yellow and magenta toner images transferred onto the intermediate transfer belt 115. The image forming unit 114 forms a black toner image, and the formed black toner image is primarily transferred to be superimposed on the yellow, magenta, and cyan toner images transferred onto the intermediate transfer belt 115.

In a lower portion of the main body 104 of the image forming apparatus 100, a sheet feed cassette 105 is provided that may be pulled out to the front side. The image forming apparatus 100 feeds the sheet P housed in the sheet feed cassette 105 with a pickup roller 106 toward a secondary transfer nip portion where the intermediate transfer belt 115 and a secondary transfer portion 116 abut on each other. When the sheet P is conveyed, the image forming apparatus 100 conveys the sheet P in synchronization with the toner image on the intermediate transfer belt 115. The multiple toner image on the intermediate transfer belt 115 is then transferred onto the sheet P at the secondary transfer nip portion by the action of the secondary transfer voltage applied to the secondary transfer portion 116.

The sheet P onto which the toner image is secondarily transferred by the secondary transfer portion 116 is conveyed to the fixing unit 118 by a conveyance belt 117. The sheet P is then heated and pressed by the fixing unit 118 so that the toner image is fixed to the sheet P. After the toner image is fixed to the surface of the sheet P, the sheet P is discharged to a sheet discharge tray 119.

According to the present exemplary embodiment, the image forming apparatus 100 includes an electrophotographic image forming unit. However, the image forming unit is not limited thereto, and can be another image forming unit, such as an inkjet image forming unit. The image forming apparatus 100 can be configured to include a post-processing apparatus that performs stapling processing, folding processing, or the like, on the sheet P having an image formed thereon.

### <Configuration of Image Reading Apparatus>

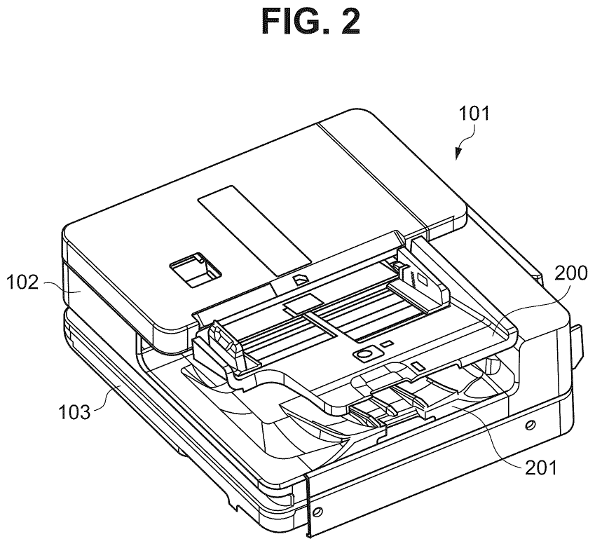

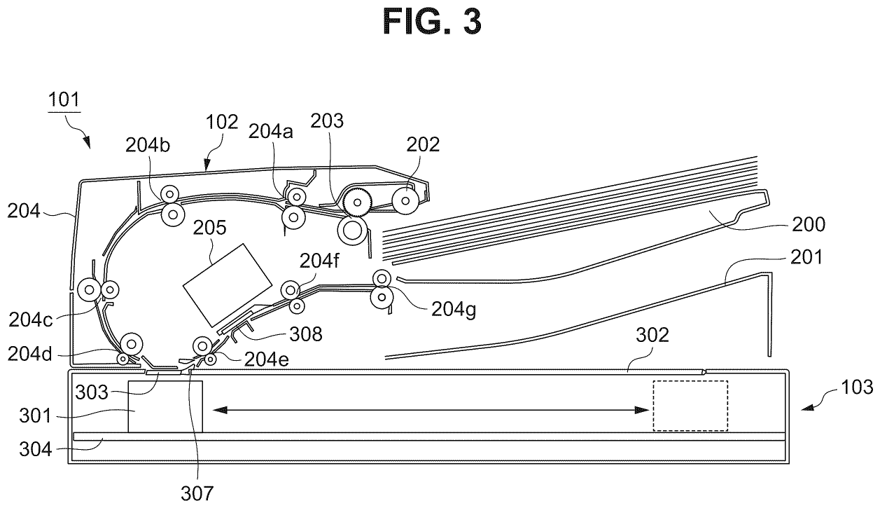

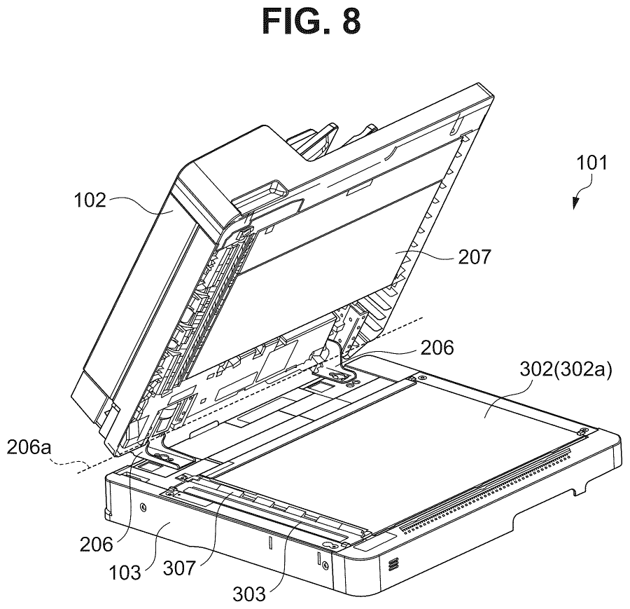

Next, the image reading apparatus 101 will be described. FIG. 2 is a perspective view of the image reading apparatus 101. FIG. 3 is a schematic cross-sectional view of the image reading apparatus 101. FIG. 8 is a perspective view of the image reading apparatus 101 in a state where an auto document feeder (ADF) 102 is opened.

The image reading apparatus 101 includes an image reading unit 103 (a reader, or a main body of the image reading apparatus 101) to read a document image and the ADF 102 provided above the image reading unit 103. As illustrated in FIG. 3, the image reading unit 103 includes a first reading unit 301 that reads image information of a document and a platen glass 302 on which a document is placed. The first reading unit 301 includes a sensor circuit board on which a charge-coupled device (CCD) image sensor serving as a light receiving element is mounted, a light source that irradiates a document with light, and a plurality of mirrors that guide reflected light from the document to an imaging surface of the light receiving element. The platen glass 302 serving as a transparent member has a placing surface 302a (see FIG. 8) that is a region where a document is placed on an upper surface thereof. The first reading unit 301 can read image information of a document placed on the platen glass 302 while moving in a sub-scanning direction (horizontal direction) below the platen glass 302. Reading an image of a document placed on the platen glass 302 in this manner is referred to as document fixed reading. The image reading unit 103 includes a first document feeding-reading glass 303. The first reading unit 301 can read image information by optically scanning the document conveyed by the ADF 102 via the first document feeding-reading glass 303 in a state where the first reading unit 301 is stopped below the first document feeding-reading glass 303. Reading an image of a document conveyed by the ADF 102 in this manner is referred to as document flow reading.

The image reading unit 103 includes a scooping guide 307 serving as a guide member. The scooping guide 307 has a guide surface inclined to rise from the left side to the right side. The lower end of the guide surface is located below the upper surface of the first document feeding-reading glass 303. The scooping guide 307 scoops the leading edge of the document having passed through the first document feeding-reading glass 303 and guides the document into the ADF 102.

The ADF 102 includes a document tray 200, a discharge tray 201 provided below the document tray 200, a conveying unit 204 that conveys a document, and a second reading unit 205 that reads an image of a document. The conveying unit 204 includes a feed roller 202, a pair of separation rollers 203, pairs of conveyance rollers 204a, 204b, 204c, 204d, 204e, and 204f, and a pair of discharge rollers 204g along a sheet conveying path through which a sheet is conveyed. A transparent second document feeding-reading glass 308 is provided between the pair of conveyance rollers 204e and the pair of conveyance rollers 204f in the sheet conveying path. The document tray 200 is a stacking tray on which sheets serving as documents are stacked. The discharge tray 201 is a discharge stacking portion to which a sheet from which image information has been read is discharged. The document tray 200 is configured to be rotatable around a rotating shaft (not illustrated) with respect to the conveying unit 204. A user can easily remove a document from the discharge tray 201 by rotating the document tray 200 upward. The second reading unit 205 has a similar configuration to that of the first reading unit 301 and reads the image of the document through the second document feeding-reading glass 308.

When a user sets a bundle of documents on the document tray 200 and provides an instruction to start a reading operation via the operating unit 130, the documents are sequentially fed to a sheet conveyance path by the feed roller 202 serving as a feeding member, starting from the uppermost document. The fed documents are separated one by one by the pair of separation rollers 203, and are conveyed through the sheet conveyance path while being sequentially passed through the pairs of conveyance rollers 204a, 204b, 204c, and 204d. The conveyed document once exits the ADF 102 and is guided to the upper surface of the first document feeding-reading glass 303. At this time, the entire document does not exit the ADF 102, and a part of the document exits the ADF 102 and is exposed on the first document feeding-reading glass 303. When the document passes through the first document feeding-reading glass 303, the first reading unit 301 reads the image information of a first surface (front surface) of the document. After passing through the first document feeding-reading glass 303, the leading edge of the document is guided into the ADF 102 again by the scooping guide 307 provided in the image reading unit 103. Thereafter, the document is conveyed by the pair of conveyance rollers 204e, and when the document passes through the second document feeding-reading glass 308, the second reading unit 205 reads the image information of a second surface (back surface) opposite to the first surface of the document.

The document from which the image information has been read is discharged by the pair of discharge rollers 204g serving as a discharge member and is stacked on the discharge tray 201. The first surface of the document is an upper surface of the document placed on the document tray 200, and the second surface of the document is a lower surface of the document placed on the document tray 200.

As illustrated in FIG. 8, the ADF 102 is supported by two hinges 206 serving as rotation support members to be rotatable with respect to the image reading unit 103 about a pivotal axis 206a extending in the left-right direction. The ADF 102 can thereby be opened and closed between an open position (the position illustrated in FIG. 8) where the ADF 102 is opened with respect to the image reading unit 103 and a closed position (the position illustrated in FIG. 2) where the ADF 102 is closed with respect to the image reading unit 103. The two hinges 206 are provided on the rear side with respect to the placing surface 302a of the platen glass 302 in the front-rear direction and are fixed to the image reading unit 103 with a space therebetween in the left-right direction. On the lower surface of the ADF 102, a pressing plate 207 is provided. The pressing plate 207 is a pressing member that presses the document against the platen glass 302. When a document is placed on the placing surface 302a of the platen glass 302, the ADF 102 is first rotated upward by the user to expose the placing surface 302a. After the document is placed on the placing surface 302a, the ADF 102 is then rotated downward so that the pressing plate 207 presses the document against the platen glass 302. It is thereby possible to read an image in a state where the document is fixed on the placing surface 302a.

### <Detailed Configuration of Image Reading Unit>

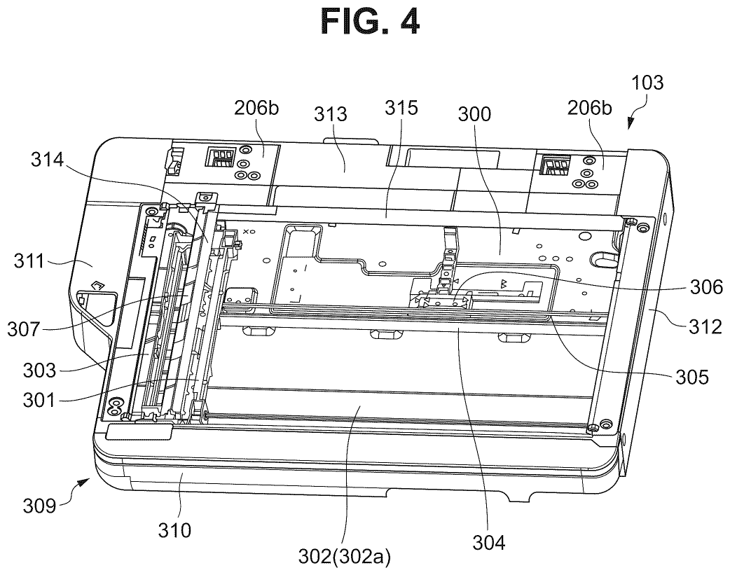

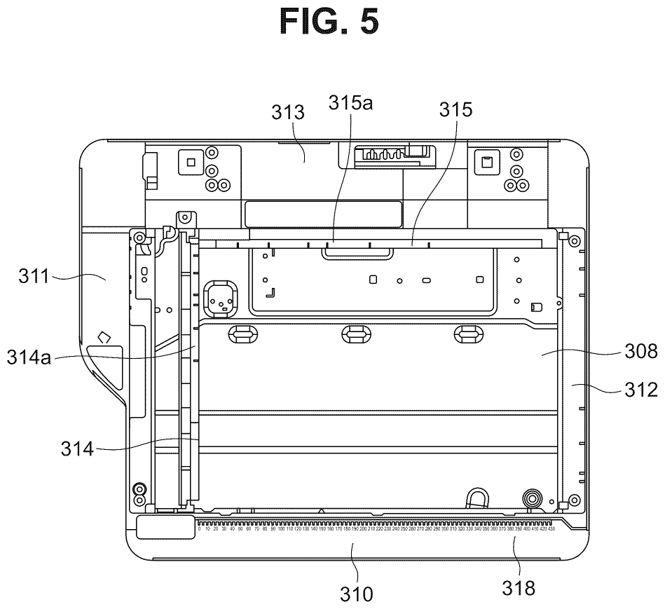

Next, a detailed configuration of the image reading unit 103 will be described. FIG. 4 is a perspective view of the image reading unit 103. FIG. 5 is a top view of the image reading unit 103. The image reading unit 103 includes a housing 300 that houses the first reading unit 301, an exterior 309 that covers the housing 300, and two hinge support portions 206b to which the two hinges 206 are respectively attached. The housing 300 is mainly formed of a metal plate-like member and houses the first reading unit 301, a shaft 304, a drive belt 305, a sheet detection sensor 306, and the like. The drive belt 305 is connected to a drive motor (not illustrated), and moves the first reading unit 301 in the sub-scanning direction along the shaft 304. The sheet detection sensor 306 detects the presence or absence of a document placed on the platen glass 302 and the size of the document.

The exterior 309 serving as an exterior cover includes a plurality of exterior cover members (e.g., a front exterior 310, a left exterior 311, a right exterior 312, and a rear exterior 313). The front exterior 310 covers a portion of the housing 300 on the front side, the left exterior 311 covers a portion of the housing 300 on the left side, the right exterior 312 covers a portion of the housing 300 on the right side, and the rear exterior 313 covers a portion of the housing 300 on the rear side. The front exterior 310, the left exterior 311, the right exterior 312, and the rear exterior 313 are each made of a resin material. The two hinge support portions 206b are provided with a space therebetween in the left-right direction on the rear side with respect to the placing surface 302a of the platen glass 302.

The platen glass 302 and the first document feeding-reading glass 303 are arranged side by side in the left-right direction on the upper surface of the housing 300. A left abutment portion 314 is provided at a left end portion of the placing surface 302a of the platen glass 302, and a rear abutment portion 315 is provided at a rear end portion of the placing surface 302a. The left abutment portion 314 and the rear abutment portion 315 are bumps protruding upward from the placing surface 302a of the platen glass 302. When the user sets a document on the platen glass 302, the left edge portion of the document abuts against the left abutment portion 314, and the rear edge portion of the document abuts against the rear abutment portion 315. The first reading unit 301 reads an image of the document in a state where the document abuts against both the left abutment portion 314 and the rear abutment portion 315, is pressed against the platen glass 302 by the pressing plate 207, and is positioned at a predetermined position. The rear abutment portion 315 is an example of a first abutment portion, and the left abutment portion 314 is an example of a second abutment portion. According to the present exemplary embodiment, in a case where the first reading unit 301 reads the image of the document, the edge portion on the left side abuts against the left abutment portion 314, but the present disclosure is not limited thereto. It is sufficient that the edge portion of the document on one side in the left-right direction may abut against the abutment portion.

### <Size Indicator>

A size indicator for indicating the size of a document will be described below. As illustrated in FIG. 5, the left abutment portion 314 is provided with a vertical size indicator 314a, and the rear abutment portion 315 is provided with a horizontal size indicator 315a. Specifically, the vertical size indicator 314a is provided on the left side with respect to the placing surface 302a of the platen glass 302, and the horizontal size indicator 315a is provided on the rear side with respect to the placing surface 302a of the platen glass 302. The vertical size indicator 314a and the horizontal size indicator 315a each have a printed mark corresponding to the size of a standard size sheet. The standard size is a sheet size determined by standards such as A4, A3, B6, B5, and 4-size business cards. The vertical size indicator 314a has a printed mark indicating the size at the position corresponding to each standard size to indicate the size of the document in a state where the edge portion of the document on the rear side abuts against the rear abutment portion 315. Similarly, the horizontal size indicator 315a has a printed mark indicating the size at the position corresponding to each standard size to indicate the size of the document in a state where the edge portion of the document on the left side abuts against the left abutment portion 314. The user can thereby check the size of the document or check whether the document is placed at a correct position in a state where the document abuts against both the left abutment portion 314 and the rear abutment portion 315. The horizontal size indicator 315a is an example of a first size indicator, and the vertical size indicator 314a is an example of a second size indicator.

A scale 318 is provided on the front side with respect to the placing surface 302a of the platen glass 302 to indicate the length of the document in the left-right direction. The scale 318 includes a straight line extending in the left-right direction and has two types of printed marks in millimeters and inches as marks indicating the length in the left-right direction. The scale 318 is used, for example, by a user to measure the length of a document having a non-fixed size or to measure the length of a recording medium to be used for printing. That is, the scale 318 is used for a different purpose from the vertical size indicator 314a and the horizontal size indicator 315a described above. More specifically, the scale 318 can measure the length of a sheet having a non-fixed size more accurately than the vertical size indicator 314a and the horizontal size indicator 315a. The origin (the position of 0 [mm], 0 [inch]) of the scale 318 is provided near the left abutment portion 314 on the right side with respect to the scooping guide 307. That is, the scale 318 is printed in an area on the right side with respect to the scooping guide 307 to not overlap with the scooping guide 307 in the left-right direction. The scale 318 extends from the origin to the side (right side) opposite to the left abutment portion 314. The scale 318 is an example of a third size indicator. The scale 318 can be configured to have a mark in either millimeters or inches.

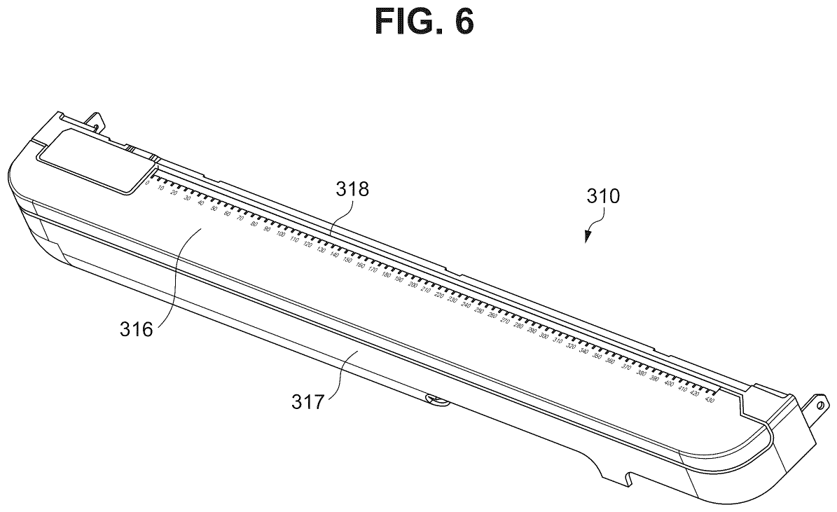

FIG. 6 is a perspective view of the front exterior 310. The front exterior 310 includes a front upper exterior 316 serving as a first cover member that covers the upper surface of the housing 300, and a front lower exterior 317 that covers the front surface of the housing 300. The scale 318 is printed on the upper surface of the front upper exterior 316 by, for example, laser engraving. The front upper exterior 316 has an outer surface having a rougher (larger) surface texture than those of the front lower exterior 317, the left exterior 311, the right exterior 312, and the rear exterior 313. That is, the front upper exterior 316 has a rougher surface than those of the other exterior cover members that cover the housing 300 on the rear side with respect to the front upper exterior 316. The left exterior 311, the right exterior 312, and the rear exterior 313 are examples of a second cover member.

In a case where the user measures the size of a sheet by using the scale 318, it is assumed that the sheet is placed on the placing surface 302a of the platen glass 302 to be measured. The upper surface of the front exterior 310 having the scale 318 printed thereon thus preferably serves as an abutment portion that protrudes upward from the placing surface 302a. The user can thereby measure the size of the sheet in a state where the edge portion of the sheet on the front side abuts against the front exterior 310.

As described above, the image reading apparatus according to the present exemplary embodiment is provided with the scale 318 on the front side with respect to the placing surface 302a of the platen glass 302 to indicate the length of the document in the left-right direction. As described above, the scale 318 is provided on the front side with respect to the placing surface 302a of the platen glass 302, and thus the visibility of the scale 318 is desirable so that the user can easily check the size of the sheet.

The vertical size indicator 314a and the horizontal size indicator 315a each have a printed mark corresponding to the size of a sheet having a standard size. This is because the vertical size indicator 314a and the horizontal size indicator 315a are sometimes used to confirm that the document is placed at a correct position. In the case of such an application, since the mark of the standard size is printed, it is easy to confirm that the document is placed at the correct position. Conversely, the scale 318 is used, for example, for the user to check the length of a document having a non-fixed size or to check the length of a recording medium used for printing. In the case of such an application, a mark in millimeters or inches is preferably printed as a mark indicating a length rather than a mark indicating a standard size. In a case where two types of marks in millimeters and inches are printed on the scale 318, the scale 318 can be used to measure various sheet sizes, which is convenient to use. Even when the mark indicating the standard size is printed on the scale 318, the visibility of the scale 318 can be improved because the scale 318 is provided on the front side with respect to the placing surface 302a of the platen glass 302.

The front upper exterior 316 having the scale 318 printed thereon has a rougher surface than those of the other exterior cover members covering the housing 300 on the rear side with respect to the front upper exterior 316. The reflection of external light on the surface of the front upper exterior 316 is thereby suppressed, and the visibility of the scale 318 is further improved. The cost required for processing can also be suppressed by increasing the surface roughness of only the front upper exterior 316 having the scale 318 printed thereon rather than by increasing the surface roughness of the entire exterior 309.

Since the exterior 309 is made of resin, the exterior 309 may be deformed when the scale 318 is printed by laser engraving. According to the present exemplary embodiment, since the front upper exterior 316 having the scale 318 printed thereon and the other exterior cover members are formed separately, it is possible to reduce the risk of deformation at the time of laser engraving.

The scale 318 is also provided to not overlap with the scooping guide 307 in the left-right direction. As described above, the scooping guide 307 has an inclined guide surface to scoop the leading edge of the document. Thus, when the scale 318 is located at a position overlapping with the scooping guide 307 in the left-right direction, the sheet to be measured overlaps on the scooping guide 307, which makes it difficult to measure the length of the sheet. Conversely, as in the present exemplary embodiment, the scale 318 is provided so as not to overlap with the scooping guide 307 in the left-right direction, it is thus possible to easily measure the sheet.

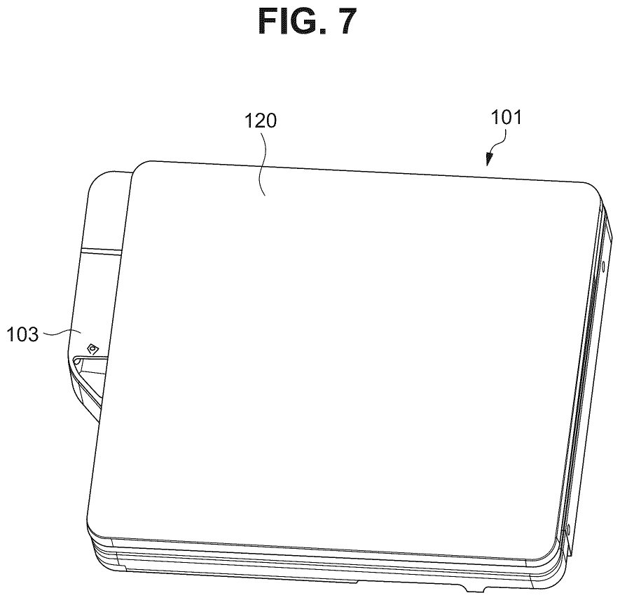

FIG. 7 illustrates another example of the image reading apparatus 101. In the image reading apparatus 101 illustrated in FIG. 7, a simple document pressing member 120 is provided instead of the ADF 102 to be rotatable with respect to the image reading unit 103. As described above, even when the image reading apparatus 101 does not include the ADF 102 serving as a sheet conveying device, the same effect as that of the above-described exemplary embodiment can be obtained.

According to the exemplary embodiment of the present disclosure, it is possible to provide an image forming apparatus with improved visibility of the size indicator when the user measures the size of a sheet.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-037565, filed Mar. 11, 2024, which is hereby incorporated by reference herein in its entirety.

What is claimed is:

1. An image reading apparatus comprising:
a transparent member having a placing surface on which a sheet is placed;
a reading unit configured to read an image of the sheet set at a predetermined position on the placing surface;
a first abutment portion against which an edge portion of the sheet on a rear side in a front-rear direction of the image reading apparatus abuts when the sheet is set at the predetermined position on the placing surface;
a second abutment portion against which an edge portion of the sheet on one side in a left-right direction orthogonal to the front-rear direction abuts when the sheet is set at the predetermined position on the placing surface;
a first size indicator provided on a rear side with respect to the placing surface in the front-rear direction and configured to indicate a size of the sheet in the left-right direction in a state where the sheet is set at the predetermined position, the first size indicator including a plurality of characters indicating a standard size;
a second size indicator provided on the one side with respect to the placing surface in the left-right direction and configured to indicate a size of the sheet in the front-rear direction in a state where the sheet is set at the predetermined position, the second size indicator including a plurality of characters indicating a standard size; and
a third size indicator provided on a front side with respect to the placing surface in the front-rear direction and configured to include a scale to measure a length of the sheet in the left-right direction.

2. The image reading apparatus according to claim 1, further comprising:
a housing configured to support the transparent member and house the reading unit; and
an exterior cover configured to cover the housing,
wherein the third size indicator is provided at the exterior cover.

3. The image reading apparatus according to claim 2,
wherein the exterior cover includes a first cover member configured to cover a portion of the housing on a front side with respect to the placing surface in the front-rear direction and a second cover member configured to cover the housing on a rear side with respect to the first cover member in the front-rear direction,
wherein the third size indicator is printed on the first cover member, and
wherein the first cover member has a rougher surface than the second cover member.

4. The image reading apparatus according to claim 1, wherein the third size indicator includes a printed mark indicating a length of the sheet in the left-right direction in millimeters or inches.

5. The image reading apparatus according to claim 1, wherein the third size indicator has two types of printed marks indicating a length of the sheet in the left-right direction in millimeters and inches.

6. The image reading apparatus according to claim 1, further comprising:
a sheet conveying device configured to convey the sheet toward the reading unit, the sheet conveying device including a stacking tray on which the sheet is stacked, a conveying unit configured to convey the stacked sheet, a discharge tray to which the conveyed sheet is discharged, and a pressing member configured to press the sheet against the transparent member; and
a guide member provided on the one side with respect to the placing surface in the left-right direction and configured to guide the sheet the sheet conveying device again after the conveyed sheet exits the sheet conveying device and an image is read by the reading unit,
wherein the third size indicator is provided at a position not overlapping with the guide member in the left-right direction.

7. An image forming apparatus comprising:
an image reading apparatus configured to read an image of a sheet; and
an image forming unit configured to form an image on a recording medium based on the read image,
wherein the image reading apparatus includes:
a transparent member having a placing surface on which the sheet is placed,
a reading unit configured to read the image of the sheet set at a predetermined position on the placing surface,
a first abutment portion against which an edge portion of the sheet on a rear side in a front-rear direction of the image reading apparatus abuts when the sheet is set at the predetermined position on the placing surface,
a second abutment portion against which an edge portion of the sheet on one side in a left-right direction orthogonal to the front-rear direction abuts when the sheet is set at the predetermined position on the placing surface,
a first size indicator provided on a rear side with respect to the placing surface in the front-rear direction and configured to indicate a size of the sheet in the left-right direction in a state where the sheet is set at the predetermined position, the first size indicator including a plurality of characters indicating a standard size,
a second size indicator provided on the one side with respect to the placing surface in the left-right direction and configured to indicate a size of the sheet in the front-rear direction in a state where the sheet is set at the predetermined position, the second size indicator including a plurality of characters indicating a standard size, and
a third size indicator provided on a front side with respect to the placing surface in the front-rear direction and configured to indicate a scale to measure a length of the sheet in the left-right direction.
